(19) United States
(12) Patent Application Publication
(10) Pub. No.: US 2011/0135797 A1
(43) Pub. Date: Jun. 9, 2011

(54) FLOCCULATION METHOD

(75) Inventors: Haihong LI, Edmonton (CA); Zhiang ZHOU, Edmonton (CA); Ross Sam CHOW, Sherwood Park (CA); Pablo CONTRERAS, Edmonton (CA)

(73) Assignee: ALBERTA INNOVATES - TECHNOLOGY FUTURES, Edmonton (CA)

(21) Appl. No.: 12/858,758

(22) Filed: Aug. 18, 2010

Related U.S. Application Data
(60) Provisional application No. 61/282,036, filed on Dec. 7, 2009.

(51) Int. Cl. B01D 21/01; C02F 1/52; A23P 1/00; E21B 43/00; E02B 15/10

(52) U.S. Cl. 426/495; 210/709; 166/267; 405/52

(57) ABSTRACT

A method is taught for producing freely draining flocculated sediment from a suspension comprising finely divided solids in water. The method comprises dispersing, at increasing concentrations, a charged particle hybrid polymer (CPHP) flocculant into the suspension to determine a minimum concentration of CPHP flocculant above which a freely draining flocculated sediment is produced that has a minimum permeability of 1 Darcy. Then, the concentration of dispersed CPHP flocculant in the suspension is maintained at or above the minimum concentration.

A method is further provided for separating fine solids and water from a suspension comprising finely divided solids in water. The method involves dispersing, at increasing concentrations, a charged particle hybrid polymer (CPHP) flocculant into the suspension to determine a minimum concentration of CPHP flocculant above which a freely draining flocculated sediment is produced that has a minimum permeability of 1 Darcy. Then, the concentration of dispersed CPHP flocculant in the suspension is maintained at or above the minimum concentration. The dispersion of CPHP flocculant in the suspension is agitated and the solid floccules are then separated from the supernatant liquid.

### RELATED APPLICATIONS

This application claims priority on U.S. Patent Application Ser. No. 61/282,036 filed Dec. 7, 2009.

### FIELD OF THE INVENTION

This invention relates to a group of hybrid polymeric flocculants for use in solid-liquid separation processes.

### BACKGROUND

Flocculation is a unit operation widely used for enhancing the separation of solids from liquid in aqueous suspensions. An organic polymeric flocculant, alone or in combination with inorganic coagulants, is normally added in the flocculation process. The most widely used flocculants are synthetic polyacrylamide (PAM)-based flocculants and derivatives thereof. Since its first use in the 1950s, PAM has found application in industries including mining and mineral processing, coal mining, pulp and paper, particularly de-inking, wastewater treatment, soil cleaning, waste oil recovery in oil and gas processing and treatment of tailings and wastewater in the oil and gas industry.

Treatment of oilsands tailings is a particularly troublesome environmental concern for the oil and gas industry, as the industry comes under increasing pressure to improve its environmental performance. Traditionally, oilsands tailings have been discharged directly from extraction to enormous tailings ponds where they are allowed to naturally settle. The fundamental drawback of this approach is the very large amount of time needed for fine tailings to settle. After a few years tailings mature into Matured Fine Tailings (MFT), having a solid loading of about content 30% by weight. MFT tend to resist further consolidation due to the high surface charges on the fine solids and residual bitumen droplets and their interactions. Tailings ponds currently in operation in the Alberta oilsands occupy a total area of more than 130 km². Given their scale, these open ponds pose significant risk of contamination to adjacent surface water resources.

The Alberta oilsands industry has been working to develop methods to eliminate or reduce the rate of accumulation of fine tailings. Since the 1990's paste technology, using commercial PAM alone or in combination with inorganic coagulants, has been tested at pilot and commercial scales. Typically, fine tailings slurry, dosed with a flocculating agent, is fed to a thickener vessel wherein the fine solids flocculate and settle. Fine tailings paste (thickened tailings) is discharged as the underflow from the thickener vessel. Warm process water can then be recycled more quickly from thickener overflow back into the extraction process, thereby saving significant amounts of thermal energy to heat process water. The fine tailings paste may be discharged to a tailings pond to allow time for further gradual dewatering and consolidation. Alternatively, the fine tailings paste may be subjected to further rapid dewatering as, for example, by centrifugation. In either case it is highly desirable that the fine tailings paste, which comprises flocculated fine solids and associated water, achieves high solids content when formed and is amenable to subsequent further dewatering and consolidation. The ultimate objective is that the paste be converted into compacted fine solids having at least a minimum solids content that corresponds to the minimum load bearing capacity to support construction traffic and enable final deposition in a reclamation operation.

To date, pilot scale testing with a combination of thickener technology and centrifugation have produced the most promising results in terms of solids loading, achieving solids loadings from 50% to 60% by weight. However, this is still short of the desired solids content for reclamation use.

Furthermore, centrifugation is a high energy separation process. The PAM-based flocculants that are currently most commonly used in commercial practice possess certain shortcomings, including:
linear PAM, having a high molecular mass, may easily be broken down into smaller, shorter molecules of polymer under mechanical mixing and turbulent flow conditions, reducing its efficiency.
ionic PAM chains become stretched by incorporation of charged anionic or cationic monomer sites that repel each other along the length of the polymer. While the presence of these charged sites on the PAM chains makes them more effective in capturing dispersed solid particles, they also limit how closely the captured particles can be drawn together. This results in loose, fragile floccules that retain large amounts of water.
PAM can only operate within a relatively narrow concentration range, outside of which its flocculating performance deteriorates, resulting in process control difficulties in large scale industrial operations. Over-dosing can result in curling of PAM molecules and associated loss of effectiveness, or results in dispersing rather than flocculating the suspended solid particles.

To improve solid-liquid separation performance using PAM, research has been carried out since the 1990s. A number of combinations of PAM, both ionic and non-ionic, in a mixture with highly charged particles of nano- to micro-particle size were examined. Tested particles include both organic polymers and inorganic minerals, with zeta potential of greater than 30 to 40 mV under natural conditions. Published results showed a marked improvement in flocculation performance using the combination of PAM and cationic charged micro-particles, over use of either component on its own. It is postulated that the underlying mechanism for the improvement is the enhanced coagulation of positively charged micro-particles with negatively charged fine solids, forming enlarged floccules with PAM as bridges. However, there is no reported practical application in solid-liquid separation, possibly due to the high cost of manufacturing charged micro-particles.

Efforts to develop hybrid organic-inorganic polymeric flocculants were also pursued in China in the early 2000's, derived in part from research on synthesizing hybrid organic-inorganic composite materials. These development efforts focused on synthesizing various hybrid polymers, including palygorskite-polyacrylamide (PGS-PAM), aluminum hydroxide-PAM (Al-PAM), and a thermal-sensitive poly (N-isopropyl acrylamide) (PNIPAM). These hybrid polymers have been tested within similar concentration ranges as that of PAM alone, to avoid the ill-effects of overdosing.

Further development of hybrid polymer flocculants is greatly needed to achieve an effective and cost effective means of separation of fine solids from liquids suspensions at an industrial scale, including oilsands tailings suspensions.

### SUMMARY

A method is provided for producing freely draining flocculated sediment from a suspension comprising finely divided solids in water. The method comprises dispersing, at increasing concentrations, a charged particle hybrid polymer (CPHP) flocculant into the suspension to determine a minimum concentration of CPHP flocculant above which a freely draining flocculated sediment is produced that has a minimum permeability of 1 Darcy. Then, the concentration of dispersed CPHP flocculant in the suspension is maintained at or above the minimum concentration.

A method is further provided for separating fine solids and water from a suspension comprising finely divided solids in water. The method involves dispersing, at increasing concentrations, a charged particle hybrid polymer (CPHP) flocculant into the suspension to determine a minimum concentration of CPHP flocculant above which a freely draining flocculated sediment is produced that has a minimum permeability of 1 Darcy. Then, the concentration of dispersed CPHP flocculant in the suspension is maintained at or above the minimum concentration. The dispersion of CPHP flocculant in the suspension is agitated and the solid floccules are then separated from the supernatant liquid.

### BRIEF DESCRIPTION OF THE DRAWINGS

The present invention will now be described in greater detail, with reference to the following drawings, in which:

FIG. 1 shows the form of the floccules produced as a result of increasing metal-hydroxide hybrid polymer (MHP) flocculant dosing concentration;

FIG. 2 shows the results of flocculation of oilsands tailings with Fe(OH)₃-PAM;

FIG. 3 shows the floccules produced from flocculation of oilsands tailings with Al(OH)₃-PAM;

FIG. 4 shows solids loading in the flocculated sediment as a function of flocculant concentration;

FIG. 5 is a graph showing settling time results of two flocculants: PAM and Al(OH)₃-PAM tested on an oilsands tailings suspension;

FIG. 6 is a graph showing settling time results of two flocculants: PAM and Al(OH)₃-PAM tested on a kaolinite suspension.

### DESCRIPTION OF THE INVENTION

The present invention relates to the applicability of charged particle hybrid polymer (CPHP) flocculants to the separation of finely dispersed solids from aqueous suspensions. More preferably, the present invention explores metal-hydroxide hybrid polymer (MHP) flocculants, a subset of CPHP flocculants, for the treatment of oilsands tailings. The inventors have further investigated the impact of increasing dosing concentrations of the present MHP flocculants. The present flocculants were tested on kaolinite and oilsands clay and fine tailings suspensions, at a variety of dosing concentrations.

Dosing concentration for the purposes of the present invention is described in parts per million (ppm), which is defined as milligrams of flocculant per litre of suspension. The inventors have surprisingly found that dosing concentrations of the present CPHP flocculants can be increased beyond the concentration ranges where conventional flocculated sediment is formed and still produce good flocculation results. If dosing is increased further, the present CPHP flocculants were found to significantly increase the solids content and robustness of individual floccules, which settle quickly and produce a flocculated sediment having high permeability and showing excellent dewatering ability.

Preferably, the minimum permeability of the flocculated sediment resulting from the present methods is 1 Darcy. More preferably, a minimum permeability of 10 Darcy is achieved and even further preferably a minimum permeability of 100 Darcy is achieved. No ill-effects previously associated with overdosing were found for the present group of flocculants.

The present CPHP flocculants comprise sub-micron size charged particles and a polymer which has been polymerized in the presence of the charged particles. When solid particles are dispersed in water, they acquire electrical charges, due to either dissolution of the solid surfaces, ionization of surface groups, adsorption of ions from the water on the surfaces, or substitution of ions in the lattice of the solids, etc. Although the whole suspension system is in electroneutrality, a difference in charge exist between the stationary layer (or plane of shear) of water attached to the dispersed particle and the bulk water. The extent of this difference is normally called zeta-potential. The polarity of zeta potential can be evaluated based on the determination of the iso-electric point (IEP) or point of zero change (PZC), where the net surface charge is zero at a given solution pH, pH_{pzc}, which varies with different types of dispersed solids. Therefore, by changing solution pH, the solids can be positively charged at solution pH less than pH_{pzc}, or negatively charged at solution pH greater than pH_{pzc}. Most mineral particles, for example clays, are negatively charged under natural conditions. For Al(OH)₃ the PZC occurs at pH between 9 and 10. The sub-micron sized particles can be metal oxides or metal hydroxides. Preferably the sub-micron sized charged particles are positively charged metal-hydroxide particles and the resulting polymer formed is a metal-hydroxide hybrid polymer (MHP) flocculant. Further preferably, but not necessarily, the polymer can be polyacrylamide (PAM) or other commercially available polymers that are known in the art to be useful as flocculants. It is understood by the inventors that ionic bonding links PAM to the surface of the positively charged metal-hydroxide particles. An exemplary MHP flocculant is illustrated below using Al(OH)₃ or Fe(OH)₃, and showing them to have a positive charge.

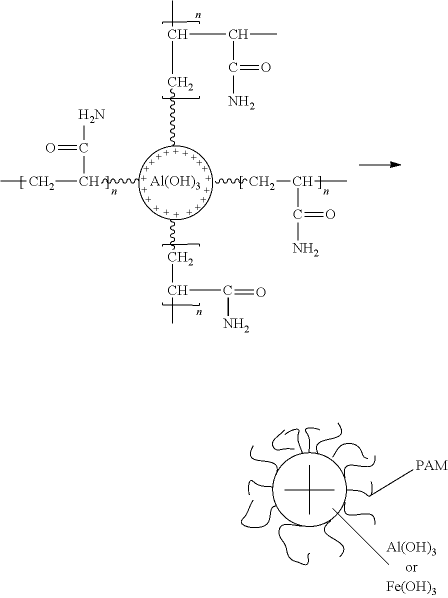

The metal is preferably, but not necessarily, a transition metal or a multivalent metal when ionized. More preferably, the metal can be aluminum or iron and the metal-hydroxides are most preferably aluminum hydroxide (Al(OH)₃) or iron hydroxide (Fe(OH)₃). Alternatively, the hydroxides may be mixed metal hydroxides.

Most preferably, but not necessarily, the flocculant can be a synthesized organic-inorganic hybrid Al(OH)₃-PAM or Fe(OH)₃-PAM flocculant.

The present group of CPHP flocculants and, more preferably MHP flocculants, have shown good flocculating results and excellent dewatering results for a number of types of suspensions. It is hypothesized that these positive results are due to the synergistic effects of both hydrogen bonding between polymer chains bonded on the charged particles and fine solids, and electrostatic attraction between the charged particle core and the oppositely charged fine solids. In the case of MHP flocculants, electrostatic attraction commonly, but not always, exists between the positively charged metal-hydroxide core and the negatively charged fine solids. The result is enhanced inter-particle attractive forces that act to squeeze out entrapped water between fine solid particles, thereby producing compacted solid agglomerates, called floccules, with high solids contents. For the model suspension systems tested, MHP flocculant concentrations above minimum concentrations produced floccules with solids loading above 45% by weight, or above 18% by volume, when converted using an estimated specific gravity of 2.5 for silica based solids. The mechanism is illustrated for clarity below:

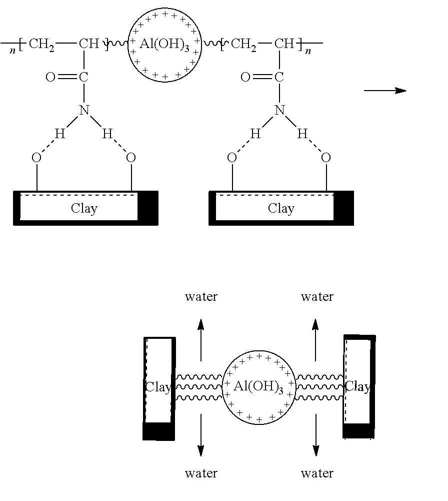

In testing MHP flocculants on kaolinite and oilsands fine tailings suspensions, the inventors steadily increased dosing concentrations until a minimum concentration level was determined, at which good solids content in the floccules, in the range of 18% by volume, was achieved. It was noted that the minimum concentration level was significantly higher than previously determined dosage ranges to produce satisfactory conventional flocculated sediment.

In a preferred embodiment, the dispersion of CPHP flocculant in the suspension is accomplished by one or more methods including stirring, mixing, mechanical agitation and injection mixing.

It was also noted that by increasing dosing beyond the minimum concentration level, solids content in the floccules was largely unchanged, producing a flocculated sediment showing good dewatering capability at these higher concentrations. Once the minimum concentration level is determined flocculant dosage concentrations can be maintained at this minimum level, or increased further. Preferably dosage concentrations are increased by from 1.2 to 3 times the minimum concentration level.

The minimum concentration of CPHP flocculant to achieve high solids loading floccules depends on the concentration and size of the suspended solid particles. It also depends on the degree of agitation applied during flocculation, wherein, up to a certain point, increased agitation results in a reduction in the minimum concentration. Very small scale testing, in graduated cylinders with mild agitation provided by shaking, often produced a single large high solids floccule. Beaker scale testing with an impeller type stirrer, in some cases inserted to the bottom and imbedded in the flocculated sediment, resulted in sediment comprising largely discrete high solids floccules. In both cases, the supernatant was readily separated from the sediment, either by decanting or by allowing the water to drain away through the flocculated sediment.

The residence time for flocculation with the present group of flocculants and flocculant dosage regime is very fast, measured in seconds. Likewise, the settling rate for the high solids floccules produced is very fast ranging from 12 mm/s to 25 mm/s on clay and mineral suspensions. Also, the turbidity of the supernatant is very low, indicating that the residual solids content of the supernatant is very low, which will contribute to reduced treatment costs and greater flexibility for reuse or disposal of the recovered water.

Settling rate, floccule quality and supernatant clarity were also not found to diminish when MHP flocculants were added at dosages higher than the minimum concentration level, showing good performance even in what have previously been considered over-dosing conditions. Achieving excellent flocculating results even at higher dosages becomes very desirable in oilsands production, since this eliminates the need to closely monitor and control the dosage of flocculant as oilsands properties change.

Furthermore, there was no detectable carry-over of metals from the MHP flocculants to the supernatant, even at dosage rates significantly above the minimum concentration.

For the model suspensions tested, the method was found to produce compacted floccules having high solids content. This is positively correlated with the mechanical robustness of the floccules and, in turn, with the formation of high permeability flocculated sediment that can be readily dewatered. Preliminary results from drained consolidation tests of the flocculated sediments of the present invention indicate that these flocculated sediments are amenable to further compaction and dewatering.

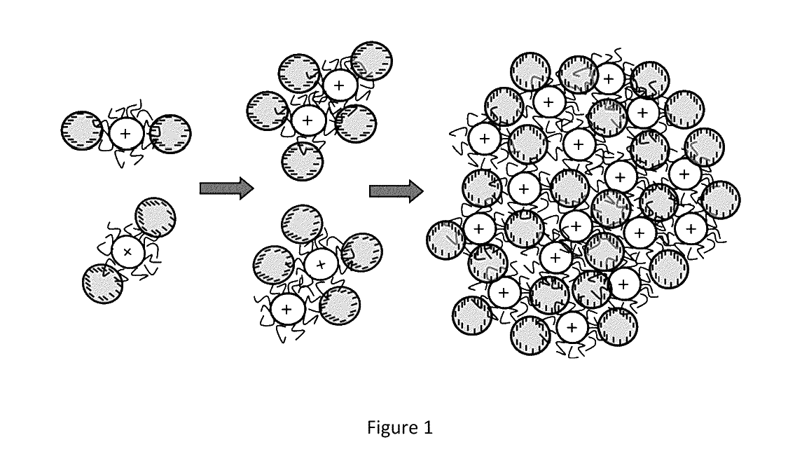

The reason for improved performance of the present CPHP flocculants at high concentration dosages is thought to be due to the unique inter-particle interaction of the present flocculants, which is not seen in conventional flocculants like PAM alone. It is hypothesized that increasing the dosage (concentration) of the present CPHP flocculants leads to increased electrostatic attractive forces between the charged particle cores and the oppositely charged fine solids, thereby leading to the formation of compacted agglomerates having very high solids content, as illustrated in FIG. 1.

The resulting dense and highly dewatered floccules produce a high permeability sediment that is readily amenable to further dewatering by commonly known means including, but not limited to screening, filtering or simply by letting the supernatant liquid drain away through the sediment.

The present CPHP flocculants showed good results on oilsands tailings and kaolinite suspension, but can also be used in a number of separation applications including, but not limited to mining and mineral processing, coal mining, pulp and paper, particularly de-inking, water treatment, wastewater treatment, soil cleaning, waste oil recovery in oil and gas processing and treatment of tailings and wastewater in oil and gas production and processing.

### EXAMPLES

The following examples serve merely to further illustrate embodiments of the present invention, without limiting the scope thereof, which is defined only by the claims.

### Example 1

1. Making MHP

Two MHPs were synthesized with different particulates: Al(OH)₃-PAM and Fe(OH)₃-PAM. Al(OH)₃-PAM was made by following a published procedure (Yang et al., 2004). Fe(OH)₃-PAM was made following a procedure similar to that used for Al(OH)₃-PAM.

MHP synthesis consists of three steps:

a. Preparation of a metal-hydroxide colloidal solution comprising sub-micron particles of metal-hydroxide. Al(OH)₃ and Fe(OH)₃ colloid solutions were prepared by a slow and dropwise addition of an ammonium carbonate solution into a metal chloride solution under agitation at room temperature (22° C.). The following reaction occurred (Li et al., 2008):

2AlCl₃+3(NH₄)2CO₃+3H₂O=2Al(OH)₃+6(NH₄)Cl+3CO₂

Agitation aids in obtaining a metal-hydroxide colloidal solution with uniform sub-micron particulate size.

b. Acrylamide monomer is dissolved in the metal-hydroxide colloidal solution and polymerized by the addition of (NH4)₂S₂O₈—NaHSO₃ as an initiator. Typically, 0.3-0.6 ml of 0.075 wt % NaHSO₃ and 0.15 wt % (NH₄)₂S₂O₈ was added to 30 ml of metal-hydroxide colloidal solution containing 4.5 g acrylamide in a 2000 ml flask. Nitrogen gas was introduced to the flask for 30 minutes before addition of the initiator. After that, the flask was sealed and polymerization proceeded for 8 h at 40° C.

c. Product separation and purification. The final step was to extract and purify the reaction product by dissolving the product in deionised water, precipitating impurities, and extracting pure MHP with an acetone solution. This procedure can be repeated twice to obtain pure product. Then the extracted material was dried at 50° C. in a vacuum oven to obtain the final MHP product.

2. Suspension Creation

The suspensions used for testing MHP were prepared by mixing fine solid samples with deionised (DI) or process water at specific solids concentrations. Two solids samples were used for the MHP testing:
Pure kaolinite sample from Dry Branch Kaolin Company with a density of 2.5 g/cm³, and median particle size of 0.2 micron. The solid slurry was prepared with DI water having 1 wt % solids and a pH adjusted to 9.0 with NaOH.
Two oilsands interbedded clay samples were obtained and had the following properties:

| # Sample | Density | Fines (−44 μm) % | Bitumen content % |
|---|---|---|---|
| Clay 1 | 2.53 | 53.14 | 4.23 |
| Clay 2 | 2.58 | 80.41 | 1.57 |

The suspension was prepared by mixing oil sands clay with process water, containing about 13.1 ppm Ca⁺⁺ and 9.2 ppm Mg⁺⁺ and allowing 10 minutes for the coarser particles to settle to obtain, as the supernatant, a suspension at pH 8.3 containing 1 wt % suspended solids with a particle size less than 10 microns.

3. Sedimentation Experiments

The fine solid suspension and the MHP flocculant at the desired dosing concentration were mixed in a 50 ml cylinder for the settling test. The cylinder was sealed with a paraffin wax film and then shaken upside down several times to mix the suspension and MHP flocculant and then placed on a solid plate to begin the settling test. A Canon G10 camera mounted on a tripod was used to take pictures at predetermined time intervals to record the descent of the solids/liquid interface, also called the mudline, in the cylinder. The image data was analyzed and transferred to a settling plot of supernatant layer height vs. settling time, which was used to determine the initial settling rate (mm/second) from the slope of the initial linear portion of the plot. All tests were conducted at room temperature of 22° C.

4. Estimation of Solid Content in Sediment was Made by Dividing the Mass of Dry Solid by the Mass of Wet, Free-Drained Sediment, and Converting to a Volume Percent.
The wet, free-drained sediment is removed from the suspension and weighed to obtain the mass of free-drained, wet sediment and then is heated in an oven (110° C.) to dry. The dry solid sediment is weighed to obtain the mass of dry solid. The weight percent is converted to a volume percent by dividing by the known densities of the sediment and of water.

Results:

a. Floccule and Supernatant Quality:

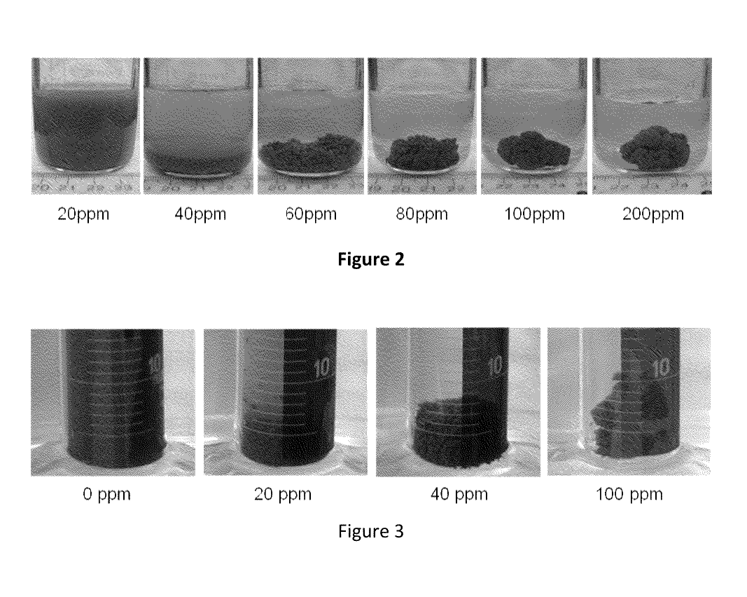

FIGS. 2 and 3 illustrate the sediments produced by using Fe(OH)₃-PAM and Al(OH)₃-PAM flocculants respectively at varying concentrations into the sample suspensions. From FIGS. 2 and 3 it is evident that a flocculant concentration of 60 ppm in the case of Fe(OH)₃-PAM and 100 ppm in the case of Al(OH)₃-PAM is sufficient to produce solid floccules with a clear supernatant liquid.

b. Solids Content in Drained Sediment:

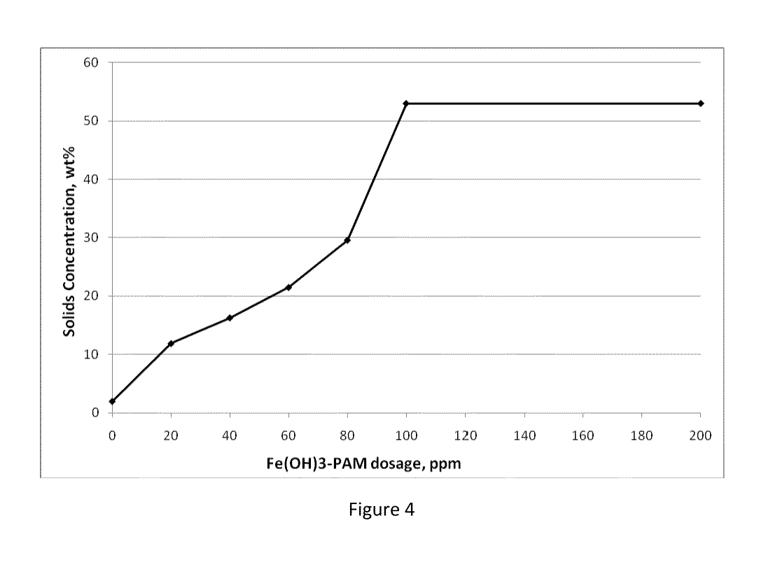

FIG. 4 shows the solids loading in the drained sediment resulting from flocculation of the sample suspension with Fe(OH)₃-PAM. Referring to FIG. 4, the solids loading in the drained sediment produced at this flocculant concentration is only 21.5% by weight or 8.6% by volume. By contrast, at a flocculant concentration of 100 ppm the solid loading in the drained flocculated sediments is 53% by weight or 21.2% by volume. It is clear that the minimum concentration, lies at a value between 80 ppm and 100 ppm for the present sample suspension and hybrid flocculant tested. Sediment with exactly the same solids loading is produced at a flocculant concentration of 200 ppm, which is at least 200% of the minimum concentration. A further observation is that large floccules may be produced at flocculant concentrations below the minimum concentration, as can be seen in FIG. 2 for a flocculant concentration of 80 ppm, which yields a solids loading in the drained flocculated sediment of only 29.6% by weight or 11.84% by volume.

c. Settling Rates:

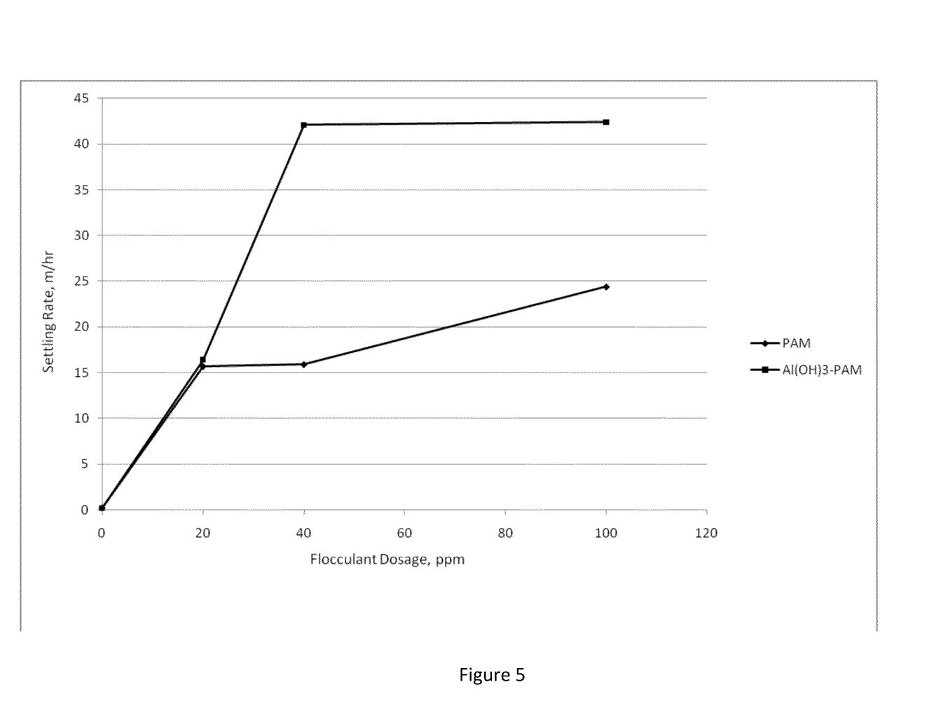

FIG. 5 compares settling rates of flocculated sediment resulting from flocculation of the present oilsands sample suspensions with PAM and Al(OH)₃-PAM. With reference to FIG. 5, a clear difference is seen in the use of, for example Al(OH)₃-PAM, versus PAM as a flocculant for oilsands tailings. In the particular example of FIG. 5, the settling rate is nearly doubled, leading to faster, cleaner separation of solids and liquid.

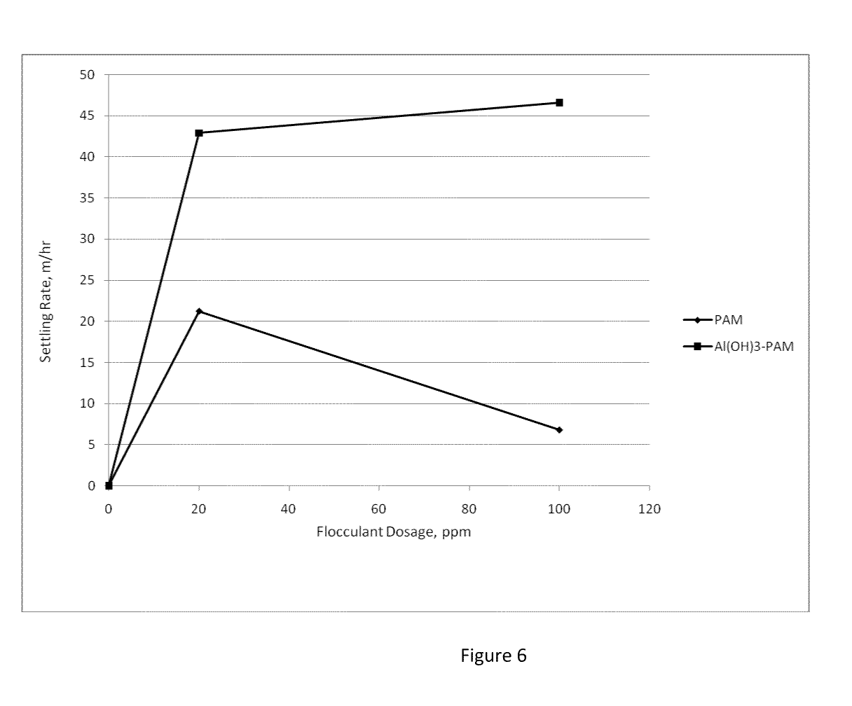

FIG. 6 compares settling rates for a kaolinite suspension treated with Al(OH)₃-PAM and PAM respectively. Again, the hybrid metal-polymer flocculant performs much better than PAM, in which settling rate actually reduces as dosage increases.

### Example 2

1. Making MHP—The MHP flocculant was prepared in the same manner as Example 1 above.

2. Suspensions Tested—The following suspensions were tested:

| | | % Solids in | |
|---|---|---|---|
| Suspension | | suspension | Fines content |
| Sample | Origin of fine solids | (% wt.) | (% <44 micron) |
| (a) | Fresh tailings from lab-scale | 10 | 18% |
| | bitumen extraction | | |
| (b) | Oilsands fines 1 | 10 | 53% |
| (c) | Oilsands fines 2 | 10 | 80% |

3. Test Method:

The following suspensions were flocculated with the following flocculants:

| | Suspension | | Flocculant dosage (ppm, |
|---|---|---|---|
| Test No. | Sample | Flocculant type | whole suspension basis) |
| 1 | (a) | PAM | 100 |
| 2 | (a) | Fe(OH)₃-PAM | 100 |
| 3 | (b) | PAM | 200 |
| 4 | (b) | Fe(OH)₃-PAM | 150 |
| 5 | (c) | PAM | 300 |
| 6 | (c) | Fe(OH)₃-PAM | 300 |

PAM denotes the commercial product designated as Magnafloc 1011, which is a high-molecular-weight medium-charge-density anionic flocculant, supplied by Ciba Specialty Chemicals Ltd. Magnafloc 1011 is reported to be a particularly good flocculant for use with oilsands fine tailings. (Cymerman, G.; Kwong, T.; Lord, E.; Hamza, H.; Xu, Y. In Polymers in Mineral Processing; J. S. Laskowski, Ed.; 38th Annual Conference of Metallurgists of CIM: Quebec, 1999; pp 605-619.)

a. The suspensions were conditioned with the added metal hybrid or PAM flocculant in a 1000 ml beaker and agitated at 300-450 rpm;

b. The conditioned slurry was then poured into a transparent tube with ID6.35 cm, a screen with an average pore size of _{—}0.6 mm to retain flocculated sediment, a conical tapered section below the screen, and a valve below the tapered section to shut off or allow flow through the sediment layer. This apparatus was first tested with clean water and no sediment layer to determine the extent of the maximum flow rate for the apparatus itself. This was measured to be 166.3 ml/sec.;

c. Settling tests were conducted, using a digital camera, controlled by a computer program to take pictures at 10 second intervals for 5 minutes.

d. A valve at the bottom of the tube was opened to allow for water drainage from the bottom of the tube to measure both the drainage rate and the amount of water removed, which also provides the amount of water remaining since the total starting amount of water is known. This approach worked well for the flocculated sediments with good drainage characteristics, tests 4 and 6. However, for tests 1, 2, 3 and 5 only a small fraction of the total water drained through the sediment. For tests I, 2, 3 and 5 the wet sediment was weighed after siphoning off as much water as possible and again after drying to determine the percent solids in the equivalent of the free drained sediment from tests 4 and 6.

e. Permeability of the sediment layer was determined in the same apparatus as used for the drainage tests referred to above. The volume of water flowing through the sediment layer was measured while maintaining a constant head of (potable Edmonton) water above the sediment layer. The measured flow rate stabilized within 10 seconds and the stabilized flow rate was used to calculate permeability. The hydrostatic head provided by the experimental apparatus was about 47 cm, which was assessed to be representative of the upper limits of what might be expected in industrial screening or filtration practice. This is an important consideration since above some threshold hydrostatic pressure the sediment bed may undergo accelerated consolidation and consequently a rapid reduction in its permeability. It was determined by observation that when a sediment layer was present, the conical section and tubing downstream from the screen were at all times flowing only partially full. Also, the measured flow rates through the apparatus when a sediment layer was present were, even for the most permeable sediments, only a fraction of those for the apparatus with no sediment layer. Therefore, for the purpose of determining the pressure drop across the sediment layer it was assumed that the pressure at the upstream side of the screen was atmospheric. Consequently the pressure drop across the sediment layer was equal to the hydrostatic pressure of the constant column of water maintained above the sediment layer. Permeability was then determined using the Darcy equation:

k=μ.L.Q/ρ.g.h.A, where:
k is the permeability of the sediment (m²);
μ is the dynamic viscosity of the fluid (Pa·s);
L is the measured thickness of the sediment layer (m);
Q is the measured flow rate through the sediment layer (m³/sec); and
ρ is the density of the fluid (Kg/m³)
g is gravitational acceleration (m/s²)
h is the measured height of water above the sediment layer (m)
A is the cross sectional area of the sediment layer (m²)

The value used for the viscosity of the potable water was 0.00089 Pa·s.

f. Compressibility was tested at 5 different pressures, each for 5 minutes. The maximum applied pressure was 28.5 kPa, which was the upper limit achievable for the experimental setup used. Discharged water is measured and recorded online by a computer program. The flocculated sediment was then removed and weighed both wet and after drying in an oven for solid content calculation.

g. Turbidity of the filtrate and of the starting process water was measured using a HACH Model 2100AN Laboratory Turbidimeter.

h. The filtrate was analyzed for dissolved calcium, magnesium and iron and compared to concentrations of these metals in the starting process water.

4. Results: The results are presented in the following tables.

| | Initial | Wt. % | Drain- | Time | Perme- | Wt. % |
|---|---|---|---|---|---|---|
| | settling | solids in | age | to zero | ability of | solids in |
| | rate | drained | through | drain- | flocculated | drained |
| Test | (mm/ | sedi- | sediment | age | sediment | compacted |
| No | sec) | ment | (ml) | (sec) | (Darcy) | sediment |
| 1 | 6.2 | 65.3 | 4.3 | 30 | na | na |
| 2 | 11.0 | 70.2 | 119.2 | 130 | na | na |
| 3 | 4.5 | 43.3 | 11.1 | 60 | na | na |
| 4 | 16.2 | 52.3 | 945.0 | 31 | 118.6 | 75.1 |
| 5 | 4.0 | 38.2 | 11.7 | 60 | na | na |
| 6 | 25.0 | 49.3 | 916.0 | 31 | 125.5 | 69.1 |

| | Turbidity | Ca²⁺ | Mg²⁺ | Fe³⁺ |
|---|---|---|---|---|
| Test No | (NTU) | (mg/l) | (mg/l) | (mg/l) |
| Process water | 12 | 13.1 | 9.2 | <0.01 |
| 1 | 80 | na | na | na |
| 2 | 4 | 16.2 | 11.3 | <0.01 |
| 3 | 1,418 | 8.7 | 6.3 | <0.01 |
| 4 | 23 | 9.8 | 7.3 | <0.01 |
| 5 | 1,237 | 6.3 | 4.6 | <0.01 |
| 6 | 28 | 6.9 | 5.1 | <0.01 |

a. Settling Rates:

Settling rates for the present MHP flocculants were much faster than that of flocculation using the PAM product. Further, for the MHP flocculants and dosages used in these tests the settling rate increases as the content of finer particles, i.e. less than 44 microns in size, increases. The increased settling rates demonstrated for MHP flocculants indicate the potential of MHP flocculants to increase the throughput capacity of thickener vessels, thus improving their economic performance.

b. Solids Content in the Drained Sediment

With MHP and suspensions with an adequate fraction of fine particles the water drained readily through and from the flocculated sediment. This was not the case for any of the tests (numbers 1, 3 and 5) using the PAM flocculant and also for the MHP test (number 2) where the suspension had a low fraction of fine particles. Despite the uncertainties associated with the different approaches to removal of free water it can be seen that the solids content, here defined as the mass of solids expressed as a percentage of the mass of solids plus the mass of associated water of the resulting dewatered (drained or siphoned) sediment, is systematically higher for the MHP tests

c. Permeability of Flocculated Sediment

Permeability of the flocculated sediment was greatly improved by use of the present MHP flocculants provided the treated suspension contained an adequate fraction of fine (less than 2 micron) particles. It was not possible to determine permeability for tests 1, 2, 3 and 5 because there was insufficient drainage through the flocculated sediment. Increased permeability enables faster and more complete separation of supernatant from the flocculated sediment with less energy input.

d. Compressibility of Flocculated Sediment

Compressibility of flocculated sediment, under free draining conditions, was examined for both the 53%<44 micron MHP sample and the 80%<44 micron MHP sample, tests 4 and 6. The solids content after compression at a maximum applied pressure of 28.5 kPa increased from 52% to 75% for test 4 and from 49% to 69% for test 6. These results indicate that MHP flocculated sediments are amenable to further dewatering in response to applied compressive loads.

e. Supernatant Quality

The quality of supernatant drained from the flocculated sediment was examined and its turbidity measured. Clear, low turbidity supernatant is desirable to minimize the amount of water treatment required and to potentially recycle the supernatant stream back into the process. Turbidity is reported in the tabulated results, from which it can be seen that flocculation with the present group of MHP flocculants produced a clearer supernatant stream containing very little suspended particles, when compared with the higher turbidity seen in supernatant resulting from suspension flocculation with PAM as the flocculant.

f. Concentration of Dissolved Metals

With the exception of the anomalous results for Test number 2, it can be seen that both the PAM and Fe(OH)₃-PAM hybrid flocculants were effective in reducing the concentration of both Ca²⁺ and Mg²⁺ compared to the starting process water. Looking at the measured concentrations of Fe³⁺ it is clear that there was no measurable loss of iron from the hybrid flocculant to the separated water.

We claim:

1. A method for producing freely draining flocculated sediment from a suspension comprising finely divided solids in water, said method comprising the steps of:
a) dispersing, at increasing concentrations, a charged particle hybrid polymer (CPHP) flocculant into the suspension to determine a minimum concentration of CPHP flocculant above which a freely draining flocculated sediment is produced that has a minimum permeability of 1 Darcy; and
b) maintaining the concentration of dispersed CPHP flocculant in the suspension at or above the minimum concentration.

2. The method of claim 1, wherein the flocculated sediment has a minimum permeability of 10 Darcy.

3. The method of claim 1, wherein the flocculated sediment has a minimum permeability of 100 Darcy.

4. The method of claim 1, wherein the flocculated sediment comprises floccules that are 18% solids by volume or greater.

5. The method of claim 1, wherein the charged particle is a sub-micron sized metal-hydroxide particle and the CPHP flocculant is a metal-hydroxide hybrid polymer (MHP) flocculant.

6. The method of claim 1, wherein the charged particle is a sub-micron sized mixed metal-hydroxide particle and the CPHP flocculant is a mixed metal-hydroxide hybrid polymer (MHP) flocculant.

7. The method of claim 5, wherein the metal is a transition metal or a metal with multivalence when ionized.

8. The method of claim 5, wherein the metal is aluminum.

9. The method of claim 5, wherein the metal is iron.

10. The method of claim 1, wherein the polymer is a commercially available polymer that is used as a flocculant.

11. The method of claim 1, wherein the polymer is polyacrylamide.

12. The method of claim 5, wherein the MHP flocculant is a synthesized organic-inorganic hybrid polymer Al(OH)₃-PAM.

13. The method of claim 5, wherein the MHP flocculant is a synthesized organic-inorganic hybrid polymer Fe(OH)₃-PAM.

14. The method of claim 1, wherein the concentration of CPHP flocculant dispersed in the suspension is maintained at from 1.2 to 3 times the minimum concentration.

15. The method of claim 1, wherein the method is applied to separation processes in one or more industries selected from the group consisting of mining and mineral processing, coal processing, coal-fired power generation, pulp and paper, de-inking, municipal water and wastewater treatment, industrial water and wastewater treatment, food processing, soil cleaning, waste oil recovery in oil and gas processing, treatment of oilsands tailings and treatment of wastewater in oil and gas production and processing.

16. The method of claim 1, wherein dispersion of CPHP flocculant into the suspension is conducted by one or more methods selected from the group consisting of mechanical stirring, mixing, or agitation, injection mixing or induced turbulent flow.

17. A method for separating fine solids and water from a suspension comprising finely divided solids in water, said method comprising the steps of:
a. dispersing, at increasing concentrations, a charged particle hybrid polymer (CPHP) flocculant into the suspension to determine a minimum concentration of CPHP flocculant above which a freely draining flocculated sediment is produced that has a minimum permeability of 1 Darcy;
b. maintaining the concentration of dispersed CPHP flocculant in the suspension at or above the minimum concentration;
c. agitating the dispersion of CPHP flocculant in the suspension; and
d. separating the solid floccules from the supernatant liquid.

18. The method of claim 17, wherein the flocculated sediment has a minimum permeability of 10 Darcy.

19. The method of claim 17, wherein the flocculated sediment has a minimum permeability of 100 Darcy.

20. The method of claim 17, wherein the flocculated sediment comprises floccules that are 18% solids by volume or greater.

21. The method of claim 17, wherein the charged particle is a sub-micron sized metal-hydroxide particle and the hybrid polymer flocculant is a metal-hydroxide hybrid polymer (MHP) flocculant.

22. The method of claim 17, wherein the charged particle is a sub-micron sized mixed metal-hydroxide particle and the hybrid polymer flocculant is a mixed metal-hydroxide hybrid polymer (MHP) flocculant.

23. The method of claim 21, wherein the metal is a transition metal or a metal with multivalence when ionized.

24. The method of claim 21, wherein the metal is aluminum.

25. The method of claim 21, wherein the metal is iron.

26. The method of claim 17, wherein the polymer is a commercially available polymer that is used as a flocculant.

27. The method of claim 17, wherein the polymer is polyacrylamide.

28. The method of claim 21, wherein the MHP flocculant is a synthesized organic-inorganic hybrid polymer Al(OH)₃-PAM.

29. The method of claim 21, wherein the MHP flocculant is a synthesized organic-inorganic hybrid polymer Fe(OH)₃-PAM.

30. The method of claim 17, wherein the concentration of CPHP flocculant dispersed in the suspension is maintained at from 1.2 to 3 times the minimum concentration.

31. The method of claim 17, wherein the method is applied to separation processes in one or more industries selected from the group consisting of mining and mineral processing, coal processing, coal-fired power generation, pulp and paper, de-inking, municipal water and wastewater treatment, industrial water and wastewater treatment, food processing, soil cleaning, waste oil recovery in oil and gas processing, treatment of oilsands tailings and treatment of wastewater in oil and gas production and processing.

32. The method of claim 17, wherein dispersion of CPHP flocculant into the suspension is conducted by one or more methods selected from the group consisting of mechanical stirring, mixing, or agitation, injection mixing or induced turbulent flow.
